(19) United States
(12) Patent Application Publication
(10) Pub. No.: US 2024/0214368 A1
(43) Pub. Date: Jun. 27, 2024

(54) AUTHENTICATION APPARATUS, AUTHENTICATION METHOD, AND COMPUTER READABLE MEDIUM

(71) Applicant: Asahi Kasei Microdevices Corporation, Tokyo (JP)

(72) Inventors: Keiichiro KUWATA, Tokyo (JP); Takaaki FURUYA, Tokyo (JP)

(21) Appl. No.: 18/391,717

(22) Filed: Dec. 21, 2023

(30) Foreign Application Priority Data
Dec. 27, 2022 (JP) 2022-209228

(51) Int. Cl. H04L 9/40; G01D 21/02

(52) U.S. Cl. CPC H04L 63/0823; G01D 21/02

(57) ABSTRACT

The authentication apparatus includes a communication unit which receives statistical information for a target transmitted from a sensor, the sensor having a measuring unit which measures environment information regarding surrounding environment of the target existing in a space and a statistics generation unit which generates, based on the environment information, the statistical information regarding the surrounding environment of the target, an authentication unit which authenticates, based on the statistical information, that the statistical information is information regarding the surrounding environment of the target, and an issuing unit which, when the statistical information has been authenticated by the authentication unit, issues an electronic certificate certifying that the statistical information authenticated is the statistical information for the target.

### BACKGROUND

### 1. Technical Field

The present invention relates to an authentication apparatus, an authentication method, and a computer readable medium.

### 2. Related Art

Patent Document 1 describes that the amount of energy used, including the amount of water used, in a facility to be managed is monitored and measured, the amount of carbon dioxide emission in the facility is calculated, and the amount of carbon dioxide emission after the lapse of a certain time is predicted based on computation from the calculated value. PRIOR ART

### DOCUMENTS

### Patent Document

Patent Document 1: Japanese Patent Application Publication No. 2009-230237

### BRIEF DESCRIPTION OF THE DRAWINGS

FIG. 1 is a diagram illustrating an example of a system configuration of an authentication system.

FIG. 2 is an example of a functional block of a sensor.

FIG. 3 is a diagram illustrating an example of a functional block of the authentication apparatus.

FIG. 4 is a diagram illustrating an example of arrangement of sensors when deriving a total amount of gas.

FIG. 5 is a diagram illustrating an example of the arrangement of the sensors when estimating gas leakage.

FIG. 6 is a flowchart illustrating an example of a procedure for transmitting statistical information of the sensor.

FIG. 7 is a flowchart illustrating an example of a procedure for issuing an electronic certificate in the authentication apparatus.

FIG. 8 is a diagram illustrating an example of a hardware configuration.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

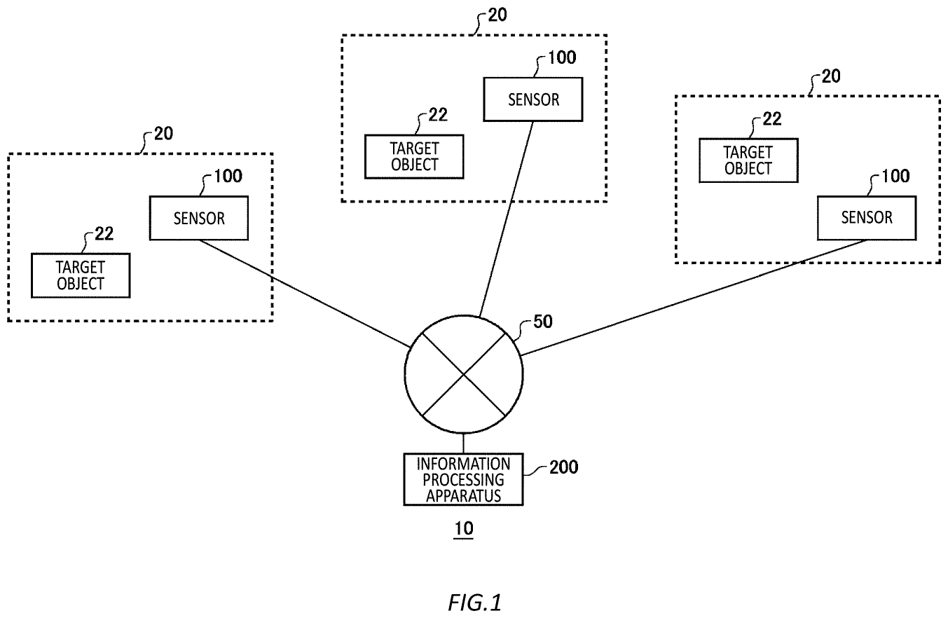

FIG. 1 is a diagram illustrating an example of a system configuration of an authentication system 10 according to the present embodiment. The authentication system 10 includes a plurality of sensors 100 and an authentication apparatus 200. The sensor 100 and the authentication apparatus 200 may be computers including a CPU and a memory, and the CPU may execute various functions by executing various programs stored in the memory. The sensor 100 and the authentication apparatus 200 communicate with each other via a network 50.

The plurality of sensors 100 may be provided at different positions in a space 20. The space 20 may be, for example, an outdoor area where a target object 22 is present. The space 20 may be an indoor area of a building, such as a house, a store, or an office, in which the target object 22 is present.

The target object 22 is an example of a target which affects or is affected by the environment measured by the sensor 100. The “target” may be an object, such as a chimney, a pipe, a facility, or a building, which exists in the space 20, may be a mobile body such as a car, a ship, or an aircraft, may be a living organism such as a human, livestock, an agricultural crop, or a plant, or may be air in a specific area within the space 20.

The sensor 100 measures environment information regarding the surrounding environment of the target object 22 existing in the space 20. The sensor 100 may be arranged around the target object 22. The sensor 100 may be installed on the outer surface or inner surface of the target object 22.

The environment information may represent at least one of a gas concentration, a dust amount, a temperature, a humidity, an atmospheric pressure, a noise, an illuminance, a vibration, an electromagnetic wave, a sound wave, an X-ray dose, a radiation dose, an ozone concentration, a flow velocity, an airflow, the number of living organisms, the postures of the living organisms, or the positions of the living organisms to be measured in the space 20. The sensor 100 may have a battery, and may be driven by electrical power from the battery. Thereby, even when there is no power supply facility for supplying power to the sensor 100 in the space 20, the sensor 100 can be driven. By driving the sensor 100 with the battery, the sensor can be installed in and moved to an arbitrary location. The sensor 100 may be mounted on a mobile body. The mobile body is a concept that includes a flying object moving in the air, a vehicle moving on the ground, a ship moving on water, or the like. The mobile body may be an unmanned mobile body. The flying object moving in the air is a concept that includes another aircraft, an airship, a helicopter, or the like which moves in the air in addition to an unmanned aerial vehicle (UAV). The mobile body may be a living organism such as a human, livestock, an agricultural crop, or a plant.

When the sensor 100 is a gas sensor, the sensor may measure a gas concentration of gas to be measured, according to a non-dispersive infrared absorption method, a photoacoustic method, a solid electrolyte method, a thermal conduction method, an acoustic wave method, or a capacitance method. The gas to be measured may be carbon dioxide, a volatile organic compound (VOC), or oxygen. The gas to be measured may be a flammable gas such as methane, propane, ethanol, or hydrogen. The gas to be measured may be a refrigerant gas such as Freon, alternative Freon, R32, or R1234yf. The gas to be measured may be a toxic gas such as carbon monoxide, hydrogen sulfide, formaldehyde, or ammonia, or a hydrogen carrier gas such as methane or MCH (methylcyclohexane). The gas to be measured may be a greenhouse gas such as nitrous oxide. The sensor 100 may be a dust sensor, a temperature/humidity sensor, a barometric pressure sensor, a noise sensor, a microphone, an illuminance sensor, a vibration sensor, an electromagnetic wave measuring instrument, a millimeter wave radar, an X-ray measuring instrument, a radiation measuring instrument, a blood sugar level sensor, a blood pressure sensor, a heart rate sensor, a thermometer, or an airflow tester.

The sensor 100 is fixed at a predetermined position in the space 20. The sensor 100 is fixed with a bolt or the like so that it cannot be easily detached from the predetermined position in the space 20. The sensor 100 may have a tamper-resistant function, and when detached from the predetermined position, detect the detachment.

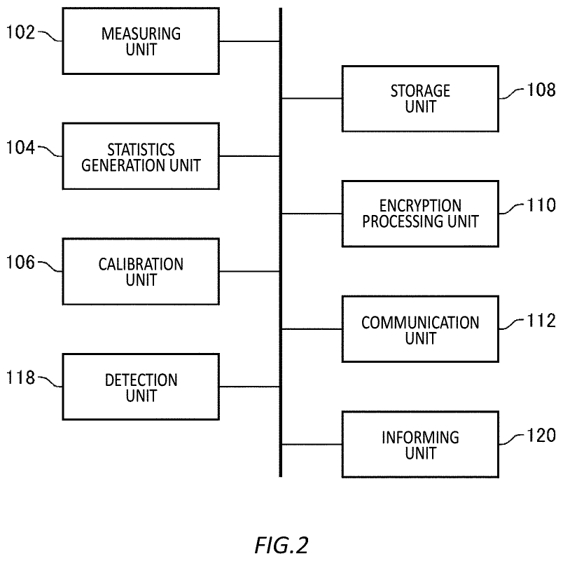

FIG. 2 is an example of a functional block of the sensor 100. The sensor 100 includes a measuring unit 102, a statistics generation unit 104, a calibration unit 106, a storage unit 108, an encryption processing unit 110, a communication unit 112, a detection unit 118, and an informing unit 120.

The measuring unit 102 measures environment information regarding the environment around the target object 22. The measuring unit 102 measures the environment information regarding the environment around the target object 22 at predetermined intervals, for example, at intervals of once every 60 seconds or more. The measuring unit 102 may include a light emitting unit which emits an infrared ray and a light receiving unit which receives the infrared ray having transmitted through a gas to be measured, and may measure a gas concentration of the gas by using an infrared absorption characteristic of the gas to be measured. The measuring unit 102 may measure gas information representing a concentration of gas in the space 20, as the environment information. The measuring unit 102 may measure carbon dioxide information representing a concentration of carbon dioxide in the space 20, as the gas information. In addition to the gas information, the measuring unit 102 may further measure temperature/humidity information representing a temperature and a humidity in the space 20, as the environment information.

In addition, the measuring unit 102 may detect whether a measurement value of the measured environment information is an abnormal value. The measuring unit 102 may determines that a measurement value x is an abnormal value when an abnormality degree α(x) of a measurement value x, which is defined by following Expression 1 where an average value and a standard deviation in past measurement value data for a certain time are respectively denoted by μ and σ, is a predetermined threshold or more.

$$\\ \begin{matrix}α ( x ) = \frac{{( x - μ )}^{2}}{{σ}^{{}_{} 2}} & ( 1 )\end{matrix}$$

In addition, the measuring unit 102 may set, as an abnormality degree β, the smallest distance, or one of the top distances when arranged in ascending order, among distances of the past measurement value data for a certain time and the measurement value x, and compare the same with a threshold, thereby determining that the measurement value x is an abnormal value. Here, the distance is a distance, which includes an absolute difference or a Mahalanobis distance, or the like, in a mathematical concept.

The statistics generation unit 104 generates, based on the environment information, statistical information regarding the surrounding environment of the target object 22. The statistics generation unit 104 continuously generates the statistical information of the environment information measured by the measuring unit 102 over a predetermined period. The statistics generation unit 104 generates, for example, the statistical information including the average value, the minimum value, and the maximum value of the gas concentration in the predetermined period. The average value, the minimum value, and the maximum value of the gas concentration are examples of statistical values. The statistics generation unit 104 stores the statistical information in the storage unit 108. The statistics generation unit 104 may generate the statistical information including at least one of the average value, the maximum value, the minimum value, the variance, the moment, or the histogram of the gas concentration in a predetermined period. The statistical information may include an abnormal value of the environment information and the frequency of the abnormal value. When generating the statistical information, a machine learning model may be used.

The communication unit 112 includes a wireless communication interface and wirelessly transmits the statistical information to the authentication apparatus 200. The communication unit 112 may transmit the statistical information to the authentication apparatus 200 by wire. The encryption processing unit 110 encrypts information that is transmitted by the communication unit 112.

The storage unit 108 stores sensor identification information for uniquely identifying the sensor 100. The sensor identification information may be a serial number of the sensor 100. The sensor identification information may represent at least one of an apparatus ID, a date of manufacture of an apparatus, a product model number, manufacturer/seller and their contact points, a manufacturing location, a warranty period, an operating principle of an apparatus, an apparatus specification, a recommended operating environment (temperature, humidity), a name of an apparatus, a manufacturing lot number, a safety standard that an apparatus meets, a disposal method, an applicable standard for a specific substance (JIS, JEDEC, etc.), a record regarding self-calibration (time, calibration data used, adjustment parameters before and after calibration), an identification number on a network, an installer name (store name, etc.), an installer contact point (telephone number, e-mail address, website URL, etc.), an installation location address, an installation date and time, or a record regarding a consent from a user to the effect that the environment information may be transmitted to an outside. The storage unit 108 may store the statistical information in association with the sensor identification information.

The communication unit 112 may transmit the sensor identification information along with the statistical information to the authentication apparatus 200. The authentication apparatus 200 may associate the statistical information with the sensor identification information and register the result in a storage unit such as a database which the authentication apparatus 200 can access. The communication unit 112 may transmit, to the authentication apparatus 200, the installer name, the installer contact point (telephone number, e-mail address, website URL), the installation location address, and the installation date and time, and the apparatus ID of the sensor 100 in response to an instruction from the user. The authentication apparatus 200 may associate installer information, regarding the installer, including the installer name, the installer contact point (telephone number, e-mail address, website URL), the installation location address, and the installation date and time with the apparatus ID of the sensor 100, and register the result in a database on a network which the authentication apparatus 200 can access. A casing of the sensor 100 may be provided with link information such as a bar code, a two-dimensional code, or RFID representing information enabling access to a website for associating the installer information and the apparatus ID. For example, by reading the link information with a camera mounted on a portable terminal such as a smartphone, the portable terminal accesses the website. Then, when the user inputs the installer information and the apparatus ID via the portable terminal, the installer information and the apparatus ID may be associated and registered in the database.

A level of access authority to the environment information stored in the storage unit 108 may be higher than a level of access authority to the statistical information stored in the storage unit 108. The environment information is detailed raw data regarding the space 20, and has a higher level of confidentiality than that of the statistical information. Therefore, from a standpoint of privacy protection, access to the environment information stored in the storage unit 108 is preferably restricted to only a specific user such as an administrator of the space 20. The statistics generation unit 104 may delete the environment information stored in the storage unit 108 in response to generating the statistical information.

The detection unit 118 detects whether the sensor 100 is installed at a predetermined position. The detection unit 118 has a tamper-resistant function, and, for example, when the detection unit detects that the screw fixing the sensor 100 is detached, the detection unit updates the installation information stored in the storage unit 108 and representing whether the sensor 100 is installed at a predetermined position. That is, when the sensor 100 is detached, the detection unit 118 updates the installation information into installation information representing that the sensor 100 is not installed at a predetermined position. The installation information may be flag information representing whether the sensor 100 is installed at a predetermined position, i.e., bit information representing “0” or “1”. The detection unit 118 may monitor a voltage of a pin connected to the casing of the sensor 100 by the tamper-resistant function, and when the voltage exceeds a threshold, the detection unit may set the flag by updating the bit information from “0” to “1”, for example. The voltage of the pin fluctuates and exceeds the threshold when the casing is opened, for example.

The detection unit 118 may include a position information acquisition function of acquiring position information representing a current position where the sensor 100 is present. The detection unit 118 may include a GNSS receiver, such as a Global Positioning System (GPS) receiver, a Global Navigation Satellite System (GLONASS) receiver, or a BeiDou Navigation Satellite System (BDS) receiver, as the position information acquisition function. The detection unit 118 may determine that the sensor 100 has been detached, and to update the installation information, when the current position of the sensor 100 is different from a position predetermined as an installation position. The communication unit 112 may transmit the installation information along with the statistical information to the authentication apparatus 200. Alternatively, the position information obtained from a position information acquisition function may be used to identify the position of the sensor 100 or the space 20, and the position of the sensor 100 or the space 20 may be stored in the storage unit 108.

The communication unit 112 may transmit failure information, which represents whether the sensor 100 is malfunctioning, to the authentication apparatus 200 along with the statistical information.

The calibration unit 106 performs calibration of the sensor 100. A characteristic of the sensor 100 may change along with the lapse of time. The characteristic of the sensor 100 refers to a characteristic of an optical element or the like, for example, when the sensor 100 is an optical element and is also a CO₂ (carbon dioxide) sensor according to the non-dispersive infrared absorption method in which a gas concentration is measured by infrared light. The characteristic of an optical element or the like may change over time. For this reason, the sensor 100 performs calibration for correcting measuring accuracy.

The calibration unit 106 may perform calibration based on a gas concentration calculated by itself and a predetermined reference gas concentration in the space 20 to be measured. The calibration unit 106 may correct a coefficient for calculating the gas concentration so that the gas concentration calculated by itself matches the reference gas concentration when a condition under which the gas concentration in the space 20 becomes the reference gas concentration is satisfied. The sensor 100 may correct the coefficient so that a minimum value of the gas concentration calculated by itself within a predetermined period matches the reference gas concentration. The condition under which the gas concentration in the space 20 becomes the reference gas concentration is, for example, a condition that a time point at which the calibration unit 106 performs calibration is a time zone in which a possibility of presence of a living organism such as a human is low. The condition under which the gas concentration in the space 20 becomes the reference gas concentration is, for example, a condition that a time point at which the calibration unit 106 performs calibration is within a predetermined period after predetermined ventilation of the space 20 is performed for a predetermined period or longer.

The storage unit 108 may store calibration information including at least one of a calibration time at which calibration should be performed by the calibration unit 106, a date and time of calibration performed by the calibration unit 106, a calibration method, or calibrator information. The calibration method is a method of calibration that is performed by the calibration unit 106. The calibration method may represent, for example, a ventilation time of the space 20, a ventilation method such as a ventilation setting of a ventilation apparatus, a time from ventilation to calibration execution, and the like. The calibration method may represent, for example, that calibration is performed within a predetermined time zone after ventilation of a predetermined ventilation time is performed in a specific time zone at night when no person is present. The communication unit 112 may transmit the calibration information along with the statistical information to the authentication apparatus 200. The calibration method may represent at least one of a type of gas to be measured, a concentration, a concentration score, a traceability system, a concentration accuracy, a gas component, a gas purchase date/calibration certificate issue date, a gas seller, a gas purchaser, a container symbol number, an expiration date of gas, a type of an adjustment parameter (for example, zero, span, offset, sensitivity), environment information at the time of calibration (temperature, humidity, atmospheric pressure, and date and time), or a residual pressure of calibration gas.

The informing unit 120 may inform an outside of a message representing the calibration time stored in the storage unit 108. The informing unit 120 may display a message representing the calibration time on a display unit of the sensor 100. The informing unit 120 may transmit a message representing the calibration time to the administrator of the space 20 via the communication unit 112 by an e-mail or the like. The informing unit 120 may deliver a message representing the calibration time to the administrator of the space 20 in writing.

The storage unit 108 may store associated information including at least one of a spatial volume of the space 20, a designed ventilation amount of the space 20, operator information for identifying an operator who uses the space 20, an installation time of the sensor 100, or an installation location of the sensor 100. The communication unit 112 may transmit the associated information along with the statistical information to the authentication apparatus 200.

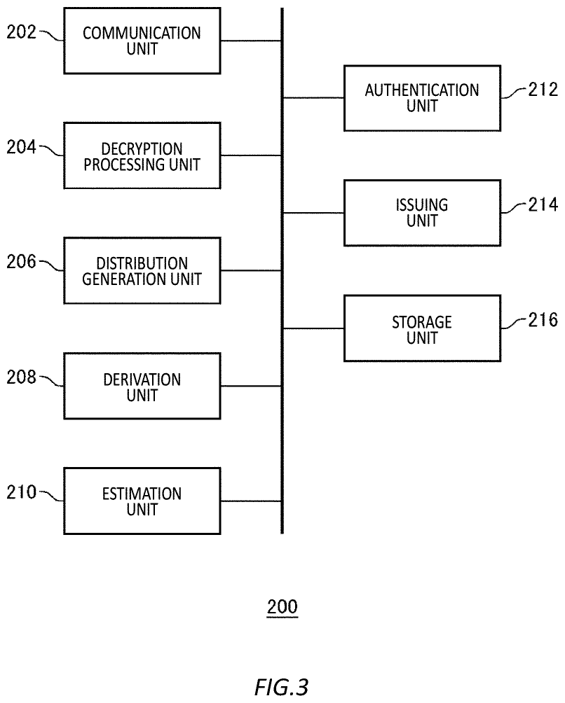

FIG. 3 is a diagram illustrating an example of a functional block of the authentication apparatus 200. The authentication apparatus 200 may include a communication unit 202, a decryption processing unit 204, a distribution generation unit 206, a derivation unit 208, an estimation unit 210, an authentication unit 212, an issuing unit 214, and a storage unit 216. The communication unit 202 receives the statistical information of the environment information from each of the plurality of sensors 100. The communication unit 202 may receive the sensor identification information, the installation information, and the associated information along with the statistical information from the sensor 100. The decryption processing unit 204 decrypts the encrypted information. The decryption processing unit 204 may decrypt the encrypted statistical information, sensor identification information, installation information, calibration information, and associated information according to a predetermined decryption algorithm.

The authentication unit 212 may include a macro statistics generation unit which further statistically processes the statistical information of the plurality of sensors 100 to generate macro statistical information.

The authentication unit 212 authenticates, based on the statistical information, that the statistical information is information regarding the surrounding environment of the target. The authentication unit 212 may authenticate, based on the statistical information and the sensor identification information, that the statistical information is information regarding the surrounding environment of the target object 22. The authentication unit 212 may authenticate, based further on the installation information, that the statistical information is information regarding the surrounding environment of the target object 22.

The authentication unit 212 authenticates, based on the macro statistical information, that the macro statistical information is information obtained by further statistically processing the statistical information regarding the surrounding environment of a plurality of targets. The authentication unit 212 may authenticate, based on the macro statistical information and a plurality of pieces of sensor identification information, that the macro statistical information is information regarding the surrounding environment of a plurality of target objects 22. The authentication unit 212 may authenticate, based further on a plurality of pieces of installation information, that the macro statistical information is information regarding the surrounding environment of the plurality of target objects 22.

The authentication unit 212 may authenticate the statistical information based on at least one of the sensor identification information, the installation information, the calibration information, or the associated information in addition to the statistical information. The authentication unit 212 may authenticate the statistical information based on the statistical information, the sensor identification information, the installation information, the calibration information, and the associated information. The storage unit 214 may store an authentication condition in association with the sensor identification information or the associated information. The authentication unit 212 may authenticate the statistical information when at least one of the statistical information, the installation information, or the calibration information satisfies the authentication condition.

The authentication unit 212 refers to the installation information and determines whether the sensor 100 is installed at a predetermined position. The authentication unit 212 refers to the calibration information and determines, based on a predetermined calibration method, whether the calibration of the sensor 100 has been performed in a predetermined period by an authorized calibrator. The authentication unit 212 authenticates the statistical information when the authentication condition for each information is satisfied, and the statistical information satisfies the authentication condition. When there are a plurality of sensors 100, the authentication unit 210 may further statistically process and authenticate the statistical information sent from the plurality of sensors 100.

When the authentication unit 212 successfully authenticates the statistical information,

the issuing unit 214 issues an electronic certificate certifying that the statistical information authenticated is the statistical information for the target object 22. The electronic certificate is an electronic document to which an electronic signature of an approval agency has been applied, the electronic document certifying that the statistical information is the statistical information for the target object 22. The communication unit 202 transmits the electronic certificate to a predetermined destination such as the administrator of the target object 22. The issuing unit 214 may associate the electronic certificate with the installer information and the apparatus ID via the communication unit 202 and register the result in the database accessible by a third party. Thereby, by accessing the database using a search system or the like, a third party can easily check whether the statistical information has been authenticated, that is, whether the statistical information for the target object 22 is accurate information which satisfies the predetermined reference and is free from irregularities.

The communication unit 202 may receive, from each of the plurality of sensors 100 arranged in a target region, the statistical information and position identifying information for identifying the position of each of the plurality of sensors 100. The distribution generation unit 206 may generate distribution information regarding the environment of the target region, based on a plurality of pieces of statistical information and a plurality of pieces of position identifying information. The distribution generation unit 206 may generate distribution information of the gas concentration of the target region. The distribution generation unit 206 may generate distribution information of a carbon dioxide concentration of the target region.

The position identifying information may be, for example, position information obtained by a Global Positioning System (GPS) receiver, position information obtained by a Global Navigation Satellite System (GLONASS) receiver, or position information obtained by a BeiDou Navigation Satellite System (BDS) receiver. In addition, the position identifying information may be position information of the installation position identified at the time of installation.

For example, when the sensor 100 is mounted on an unmanned mobile body or an unmanned aerial vehicle (drone), the distribution generation unit 206 may generate distribution information regarding the environment of the target region, based on the statistical information, the position identifying information, and the time information of the sensor 100.

The communication unit 202 may receive the distribution information, regarding environment in a wide region including the target region, based on an observation result obtained by an observation satellite which observes the environment information regarding the environment in the wide region. The communication unit 202 may receive the distribution information based on the observation result from a server which manages the distribution information, regarding the environment in the wide region, based on the observation result. The distribution generation unit 206 may generate the distribution information regarding the environment of the target region, based on the plurality of pieces of statistical information, the plurality of pieces of position identifying information, and the distribution information based on the observation result. The distribution generation unit 206 may generate gas concentration distribution information in which the distribution information of the gas concentration of the target region based on the plurality of pieces of statistical information and the plurality of pieces of position identifying information is combined with the distribution information of the gas concentration from the observation satellite. The distribution generation unit 206 may generate gas concentration distribution information in which the distribution information of the gas concentration of the target region based on the plurality of pieces of statistical information and the plurality of pieces of position identifying information is superimposed with the distribution information of the gas concentration from the observation satellite. The distribution generation unit 206 may generate gas concentration distribution information obtained when the distribution information of the gas concentration of the target region based on the plurality of pieces of statistical information and the plurality of pieces of position identifying information is interpolated using the distribution information of the gas concentration from the observation satellite.

In addition, when generating the distribution information of the gas concentration, the observation result obtained from the sensor 100, the gas concentration distribution information from the observation satellite as necessary, and a numerical forecast model/fluid simulation result may be subjected to data assimilation by using a four-dimensional variational method or the like to generate the distribution information of the gas concentration. Specifically, when J denotes an evaluation function, x0 denotes an estimated value (vector quantity) of the distribution information of the gas concentration, xb denotes a predicted value (vector quantity) obtained in advance from the numerical forecast model/fluid simulation result, the data assimilation, or the like, xt denotes the estimated value (vector quantity) of the distribution information of the gas concentration at time t, yt denotes an observed value (vector quantity) at time t, H denotes an observation operator for converting the estimated distribution xt into an observed value assumed corresponding to the actual observed value yt, B denotes an error covariance matrix between the estimated value x0 and the predicted value xb, and R denotes an error covariance matrix between the observed value yt and the assumed observed value H(xt), the evaluation function J is expressed by the following expression (note that the sum at time t is defined over a set time interval having t, and a right superscript T denotes transposition).

$$\\ \begin{matrix}α ( x ) = \frac{{( x - μ )}^{2}}{{σ}^{{}_{} 2}} & ( 1 )\end{matrix}$$

The four-dimensional variational method can be performed by estimating x0 so as to minimize this evaluation function J. In estimating x0 which minimizes the evaluation function J, an adjoint method may be used.

When the statistical information has been authenticated by the authentication unit 212, the issuing unit 214 may issue an electronic certificate certifying that the distribution information generated by the distribution generation unit 206 is distribution information based on the statistical information for the target object 22.

Furthermore, based on the obtained gas concentration distribution and computation by computational fluid dynamics (CFD), the derivation unit 208 may interpolate and predict the gas concentration distribution, and further derive the total amount of gas. Specifically, by performing data assimilation on the gas concentration distribution obtained by the four-dimensional variational method and the predicted value of the gas concentration distribution obtained by the CFD computation, the derivation unit 208 may interpolate and predict the gas concentration distribution, and further compute the total amount of gas. In addition, in the case of computing the total amount of gas leakage due to leaks from pipelines or the like, when gas is recovered by another method, a difference between the computed amount of gas leakage and the amount of gas recovery may be used as the actual total amount of leaked gas.

When the statistical information has been authenticated by the authentication unit 212, the issuing unit 214 may issue an electronic certificate certifying that the total amount of gas generated by the distribution generation unit 206 is the total amount of gas based on the statistical information for the target object 22.

When there are a plurality of electronic certificates certifying the total amounts of gas at a plurality of points, the issuing unit 214 may further issue an electronic certificate certifying the total amount of gas obtained by aggregating them.

The measuring unit 102 may measure, as the environment information, the concentrations of the methane and carbon dioxide emitted from the target object 22 of livestock such as a beef cow or a dairy cow or an agricultural crop such as rice. For example, air around a beef cow or a dairy cow is sucked in with a pump, and the concentrations of methane and carbon dioxide in the sucked air are measured. The statistics generation unit 104 generates, as the statistical information, the statistical values of the concentrations of methane and carbon dioxide.

The derivation unit 208 may derive, based on the statistical values of the methane and carbon dioxide concentrations represented by the statistical information, the total amount of the methane gas emitted from the target object 22 (beef cow or dairy cow). For example, the statistically processed ratio of the methane concentration to the carbon dioxide concentration is substituted into a methane emission amount estimation expression, so as to derive the total amount of the methane gas emitted from the target object 22 (beef cow or dairy cow).

When the statistical information has been authenticated by the authentication unit 212, the issuing unit 214 may issue an electronic certificate certifying that the total amount of gas derived by the derivation unit 208 is the total amount of the methane gas emitted from the target object 22 (beef cow or dairy cow).

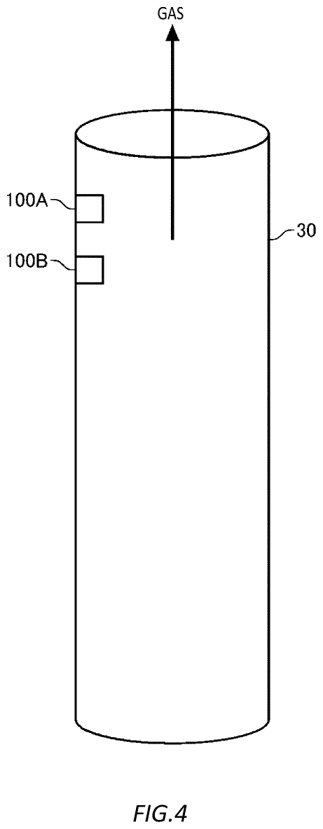

The measuring unit 102 may measure, as the environment information, the gas concentration and the gas outflow amount of the gas passing through the target object 22 such as a chimney or a pipe. For example, as illustrated in FIG. 4, a sensor 100A which measures a concentration c (ppm) of greenhouse gases such as carbon dioxide and a sensor 100B which measures a flow velocity v (m/s) of the greenhouse gases are provided near the exhaust port of a chimney 30. The statistics generation unit 104 generates, as the statistical information, the statistical values of a gas concentration c and a gas flow velocity v.

The derivation unit 208 derives, based on the statistical values of the gas concentration c and the gas flow velocity v represented by the statistical information, the total amount of the gas passing through the target object 22. The derivation unit 208 may derive a gas outflow amount V (m³/s) according to V=Sv(c−c₀). Here, S is an inner diameter area near the exhaust port of the chimney, and c₀ is a gas background concentration. The gas background concentration is a gas concentration when there is no gas emitted from the chimney. For example, the gas background concentration may be an actual measurement value of the gas concentration when the chimney is not in operation, or may be an average value or a representative value of the gas concentration of the outside air in a surrounding region. When the outflow amount V of gas can be derived, the derivation unit 208 can derive the total amount of the gas passing through the target object 22 by multiplying the outflow amount V by gas emission time. That is, the derivation unit 208 can derive the emission amount of the greenhouse gases emitted from the chimney 30.

When the statistical information has been authenticated by the authentication unit 212, the issuing unit 214 may issue an electronic certificate certifying that the total amount of gas derived by the derivation unit 208 is the total amount of the gas passing through the target object 22.

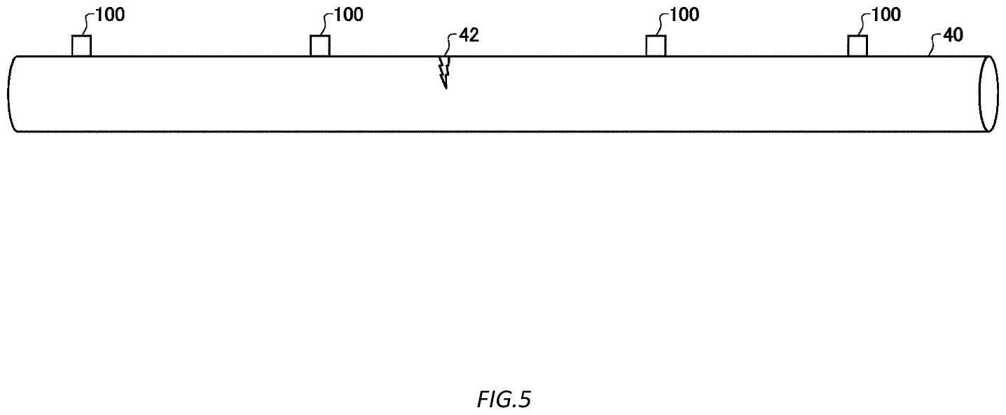

As illustrated in FIG. 5, the plurality of sensors 100 may be provided on the outer surface of the pipe 40 through which a gas passes. The estimation unit 210 may estimate the position and leakage amount of the gas leaking from the pipe 40 which is the target object 22, based on the plurality of pieces of statistical information from the plurality of sensors 100. When the statistical information has been authenticated by the authentication unit 212, the issuing unit 214 may issue an electronic certificate certifying that the position and leakage amount of the gas estimated by the estimation unit 210 are the position and leakage amount of the gas leaking from the target object 22.

The estimation unit 210 may estimate, for example, a gas leakage position according to following Expressions 2 and 3.

$$\\ \begin{matrix}α ( x ) = \frac{{( x - μ )}^{2}}{{σ}^{{}_{} 2}} & ( 1 )\end{matrix}$$

rᵢ is the position of the i-th sensor 100.

a and b are estimated parameters.

r₀ is the estimated position of gas leakage.

Cₘ(rᵢ) is the gas concentration measured by the sensor 100 at the position rᵢ.

Cp(rᵢ) is the gas concentration estimated at the position rᵢ.

The estimation unit 210 can estimate the gas leakage position by searching for a, b, and r₀ which minimize W in Expression 2.

The measuring unit 102 may measure, as the environment information, the sound or vibration generated from the target object 22 of a manufacturing facility or a processing facility. The statistics generation unit 104 generates, as the statistical information, the statistical value of the sound or vibration.

The derivation unit 208 may derive the failure probability or abnormality degree of the target object 22 based on the statistical value of the sound or vibration represented by the statistical information.

When the statistical information has been authenticated by the authentication unit 212, the issuing unit 214 may issue an electronic certificate certifying the failure probability or abnormality degree of the target object 22 derived by the derivation unit 208.

The measuring unit 102 may measure, as the environment information, the millimeter wave radar information or carbon dioxide concentration measured inside the target object 22 of a mobile body such as a car. The statistics generation unit 104 generates, as the statistical information, the statistical value of the millimeter wave radar information or carbon dioxide concentration.

The derivation unit 208 may derive, based on the statistical value of the millimeter wave radar information or carbon dioxide concentration represented by the statistical information, whether there is a person left behind in the target object 22.

When the statistical information has been authenticated by the authentication unit 212, the issuing unit 214 may issue an electronic certificate certifying whether there is a person left behind in the target object 22 derived by the derivation unit 208.

The measuring unit 102 may measure, as the environment information, the internal temperature and humidity of the target object 22 of a building. The statistics generation unit 104 generates, as the statistical information, the statistical values of the temperature and the humidity.

The derivation unit 208 may derive the heat index of the target object 22 based on the statistical values of the temperature and the humidity represented by the statistical information. For example, the heat index may be a wet bulb globe temperature (WBGT) value.

When the statistical information has been authenticated by the authentication unit 212, the issuing unit 214 may issue an electronic certificate certifying the internal heat index of the target object 22 derived by the derivation unit 208.

The measuring unit 102 may measure, as the environment information, at least one of sound, postures, or vital signs regarding the target object 22 such as a person. The statistics generation unit 104 generates, as the statistical information, the statistical value of at least one of sound, postures, or vital signs.

The derivation unit 208 derives the biological state of the target object 22 based on the statistical value of at least one of sound, postures, or vital signs represented by the statistical information. For example, the biological state may be a state such as presence or absence of sleep apnea syndrome, presence or absence of falls, or wake-up or sleep.

When the statistical information has been authenticated by the authentication unit 212, the issuing unit 214 may issue an electronic certificate certifying the biological state of the target object 22 derived by the derivation unit 208.

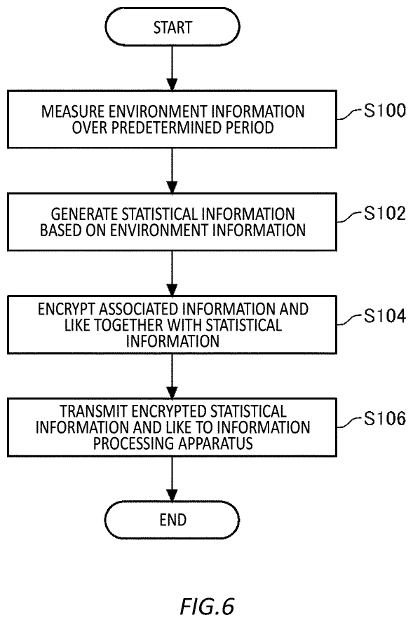

FIG. 6 is a flowchart illustrating an example of a procedure for transmitting the statistical information of the sensor 100.

The measuring unit 102 measures environment information such as a gas concentration to be measured around the target object 22 in the space 20 at predetermined intervals (for example, once every 60 seconds) over a predetermined period (for example, one month or the like) (S100). The measuring unit 102 may store the environment information in the storage unit 216. The statistics generation unit 104 generates statistical information based on the environment information measured in the predetermined period and stored in the storage unit 108 (S102). When the generation of the statistical information is completed, the statistics generation unit 104 may delete the environment information stored in the storage unit 108. The encryption processing unit 110 acquires the sensor identification information, the installation information, the calibration information, and the associated information from the storage unit 108 and encrypts the information together with the statistical information (S104). The communication unit 112 transmits the encrypted statistical information and the like to the authentication apparatus 200 (S106).

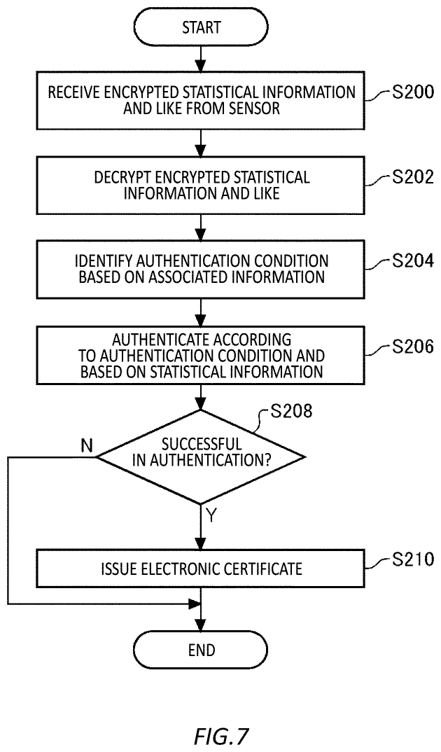

FIG. 7 is a flowchart illustrating an example of a procedure for issuing an electronic certificate in the authentication apparatus 200.

The communication unit 202 receives the encrypted statistical information and the like from the sensor 100 (S200). The decryption processing unit 204 decrypts the encrypted statistical information and the like (S202). The authentication unit 212 refers to the authentication conditions stored in the storage unit 216 and identifies, based on the decrypted associated information, an authentication condition associated with the space 20 (S204).

The authentication unit 212 performs authentication according to the authentication condition, based on the statistical information (S206). The authentication unit 212 determines whether authentication has been successful (S208). If authentication has been successful, the issuing unit 214 issues an electronic certificate certifying that the statistical information authenticated is the statistical information for the target object 22 (S210). If authentication has not been successful, the authentication apparatus 200 ends the processing.

Hereinbefore, according to the present embodiment, since the plurality of sensors 100 do not transmit, to the authentication apparatus 200, the environment information as it is, but generate the statistical information from the environment information and transmits the statistical information to the authentication apparatus 200, the processing load on the authentication apparatus 200 which aggregates information from the plurality of sensors 100 can be reduced.

The electronic certificate can be used to certify the distribution information of the environment, the total amount of gas, or the position of gas leakage based on the authenticated statistical information.

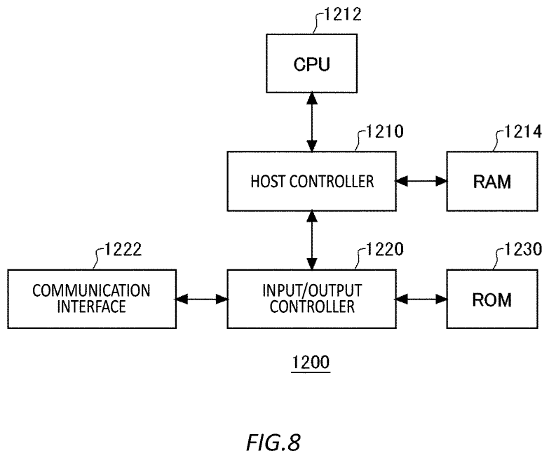

FIG. 8 illustrates an example of a computer 1200 in which a plurality of aspects of the present invention may be embodied in whole or in part. Programs installed in the computer 1200 can cause the computer 1200 to function as operations associated with the apparatus according to the embodiments of the present invention or one or more “units” of the apparatuses. Alternatively, the programs can cause the computer 1200 to execute the operations or the one or more “units”. The programs can cause the computer 1200 to execute a process according to the embodiments of the present invention or steps of the process. Such programs may be executed by a CPU 1212 to cause the computer 1200 to perform specific operations associated with some or all of the blocks in the flowcharts and block diagrams described in the present specification.

The computer 1200 according to the present embodiment includes the CPU 1212 and a RAM 1214, which are mutually connected by a host controller 1210. The computer 1200 also includes a communication interface 1222 and an input/output unit, which are connected to the host controller 1210 via an input/output controller 1220. The computer 1200 also includes a ROM 1230. The CPU 1212 operates according to the programs stored in the ROM 1230 and the RAM 1214, thereby controlling each unit.

The communication interface 1222 communicates with other electronic devices via a network. A hard disk drive may store the programs and data used by the CPU 1212 in the computer 1200. The ROM 1230 stores therein boot programs or the like executed by the computer 1200 at the time of activation, and/or stores programs depending on hardware of the computer 1200. A program is provided via a computer-readable recording medium such as a CD-ROM, a USB memory, or an IC card, or via a network. The programs are installed in the RAM 1214 or the ROM 1230 which is also an example of the computer readable recording medium, and executed by the CPU 1212. Information processing written in these programs is read by the computer 1200, and provides cooperation between the programs and the various types of hardware resources described above. An apparatus or a method may be configured by implementing operations or processing of information according to a use of the computer 1200.

For example, in a case where a communication is performed between the computer 1200 and an external device, the CPU 1212 may execute a communication program loaded in the RAM 1214 and instruct the communication interface 1222 to perform communication processing based on a process written in the communication program. The communication interface 1222, under the control of the CPU 1212, reads transmission data stored in a transmission buffer region provided in a recording medium such as the RAM 1214 or the USB memory, transmits the read transmission data to the network, or writes reception data received from the network to a reception buffer region or the like provided on the recording medium.

In addition, the CPU 1212 may cause all or necessary portion of a file or a database stored in an external recording medium such as a USB memory, to be read by the RAM 1214, and execute various types of processing on the data on the RAM 1214. Then, the CPU 1212 may write the processed data back in the external recording medium.

Various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information retrieval/replacement, or the like described throughout the present disclosure and specified by instruction sequences of the programs, to write the results back to the RAM 1214. In addition, the CPU 1212 may retrieve information in a file, a database, or the like in the recording medium. For example, when a plurality of entries each having an attribute value of a first attribute associated with an attribute value of a second attribute are stored in the recording medium, the CPU 1212 may retrieve, out of the plurality of entries, an entry with the attribute value of the first attribute specified that meets a condition, read the attribute value of the second attribute stored in the entry, and thereby acquire the attribute value of the second attribute associated with the first attribute meeting a predetermined condition.

The programs or software module described above may be stored on the computer 1200 or in a computer readable storage medium near the computer 1200. In addition, a recording medium such as a hard disk or a RAM provided in a server system connected to a dedicated communication network or the Internet can be used as the computer readable storage medium, so that the programs are provided to the computer 1200 via the network.

A computer readable medium may include any tangible device that can store instructions to be executed by a suitable device. As a result, the computer readable medium having instructions stored therein includes an article of manufacture including instructions which can be executed to create means for performing operations specified in the flowcharts or block diagrams. Examples of the computer readable medium may include an electronic storage medium, a magnetic storage medium, an optical storage medium, an electromagnetic storage medium, a semiconductor storage medium, and the like. More specific examples of the computer readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM (registered trademark)), a static random access memory (SRAM), a compact disc read-only memory (CD-ROM), a digital versatile disk (DVD), a Blu-ray (registered trademark) disk, a memory stick, an integrated circuit card, and the like.

Computer readable instructions may include either a source code or an object code written in any combination of one or more programming languages. The source code or the object code includes a conventional procedural programming language. The conventional procedural programming language may be assembler instructions, instruction-set-architecture (ISA) instructions, machine instructions, machine dependent instructions, microcode, firmware instructions, state-setting data, or an object oriented programming language such as Smalltalk (registered trademark), JAVA (registered trademark), C++, etc., and programming languages, such as the “C” programming language or similar programming languages. Computer readable instructions may be provided to a processor of a general purpose computer, special purpose computer, or other programmable data processing device, or to programmable circuitry, locally or via a local area network (LAN), a wide area network (WAN) such as the Internet, etc. The processor or the programmable circuitry may execute the computer readable instructions in order to create means for performing operations specified in the flowcharts or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above described embodiments. It is apparent to persons skilled in the art that various alterations or improvements can be made to the above described embodiments. It is also apparent from description of the claims that the embodiments to which such alterations or improvements are made can be included in the technical scope of the present invention.

It should be noted that the operations, procedures, steps, stages, and the like of each process performed by an apparatus, system, program, and method shown in the claims, embodiments, or diagrams can be realized in any order as long as the order is not indicated by “prior to,” “before,” or the like and as long as the output from a previous process is not used in a later process. Even if the operation flow is described using phrases such as “first” or “next” for the sake of convenience in the claims, specification, or drawings, it does not necessarily mean that the process must be performed in this order.

### (Item 1)

An authentication apparatus including:

a communication unit which receives statistical information for a target transmitted from a sensor, the sensor having a measuring unit which measures environment information regarding surrounding environment of the target existing in a space and a statistics generation unit which generates, based on the environment information, the statistical information regarding the surrounding environment of the target; and

an authentication unit which authenticates, based on the statistical information, that the statistical information is information regarding the surrounding environment of the target.

### (Item 2)

The authentication apparatus according to item 1, further including an issuing unit which, when the statistical information has been authenticated by the authentication unit, issues an electronic certificate certifying that the statistical information authenticated is the statistical information for the target.

### (Item 3)

The authentication apparatus according to item 1, wherein the environment information represents at least one of a gas concentration, a dust amount, a temperature, a humidity, an atmospheric pressure, a noise, an illuminance, a vibration, an electromagnetic wave, a sound wave, an X-ray dose, a radiation dose, an ozone concentration, an airflow, the number of living organisms, postures of the living organisms, or positions of the living organisms to be measured in the space.

### (Item 4)

The authentication apparatus according to item 1, wherein the statistical information includes at least one of an average value, a maximum value, a minimum value, a variance, a moment, or a histogram of measured values which are the environment information.

### (Item 5)

The authentication apparatus according to item 1, wherein

the communication unit receives, from the sensor and along with the statistical information, sensor identification information that is for uniquely identifying the sensor, and

the authentication unit authenticates, based on the statistical information and the sensor identification information, that the statistical information is information regarding the surrounding environment of the target.

### (Item 6)

The authentication apparatus according to item 5, wherein

the sensor is installed at a predetermined position of the space,

the sensor has a detection unit which detects whether the sensor is installed at the predetermined position, and a storage unit which stores installation information representing whether the sensor is installed at the predetermined position,

the communication unit receives the installation information along with the statistical information from the sensor, and

the authentication unit authenticates, based further on the installation information, that the statistical information is information regarding the surrounding environment of the target.

### (Item 7)

The authentication apparatus according to item 1, wherein

the sensor includes a plurality of sensors, each being identical to the sensor and arranged in a target region, and the communication unit receives, from each of the plurality of sensors, the statistical information and position identifying information for identifying a position of each of the plurality of sensors, and

the authentication apparatus further includes:

a distribution generation unit which generates distribution information regarding environment of the target region, based on a plurality of pieces of statistical information, each being identical to the statistical information, and on a plurality of pieces of position identifying information, each being identical to the position identifying information.

### (Item 8)

The authentication apparatus according to item 7, wherein

the communication unit receives distribution information, regarding environment of a wide region, based on an observation result obtained by an observation satellite which observes environment information regarding the environment of the wide region including the target region, and

the distribution generation unit generates the distribution information regarding the environment of the target region, based on the plurality of pieces of statistical information and the plurality of pieces of position identifying information, and on the distribution information based on the observation result.

### (Item 9)

The authentication apparatus according to item 7, further including

an issuing unit which, when the statistical information has been authenticated by the authentication unit, issues an electronic certificate certifying that the statistical information authenticated is the statistical information for the target, wherein

when the statistical information has been authenticated by the authentication unit, the issuing unit issues the electronic certificate certifying that the distribution information generated by the distribution generation unit is distribution information based on the statistical information for the target.

### (Item 10)

The authentication apparatus according to item 7, further including

an issuing unit which, when the statistical information has been authenticated by the authentication unit, issues an electronic certificate certifying that the statistical information authenticated is the statistical information for the target, wherein

when the statistical information has been authenticated by the authentication unit, the issuing unit issues the electronic certificate certifying that the distribution information generated by the distribution generation unit is the distribution information regarding the environment of the target region.

### (Item 11)

The authentication apparatus according to item 1, wherein

the measuring unit measures, as the environment information, a gas concentration and a gas flow velocity of a gas passing through the target,

the statistics generation unit generates, as the statistical information, statistical values of the gas concentration and the gas flow velocity, and

the authentication apparatus further includes:

a derivation unit which derives, based on the statistical values of the gas concentration and the gas flow velocity represented by the statistical information, a total amount of the gas passing through the target.

### (Item 12)

The authentication apparatus according to item 11, further including

an issuing unit which, when the statistical information has been authenticated by the authentication unit, issues an electronic certificate certifying that the statistical information authenticated is the statistical information for the target, wherein

when the statistical information has been authenticated by the authentication unit, the issuing unit issues the electronic certificate certifying that the total amount of the gas derived by the derivation unit is a total amount of the gas passing through the target.

### (Item 13)

The authentication apparatus according to item 12, wherein the gas is a greenhouse gas.

### (Item 14)

The authentication apparatus according to item 1, wherein

the sensor includes a plurality of sensors, each being identical to the sensor, the plurality of sensors being arranged at a plurality of positions of the target,

the communication unit receives the statistical information from each of the plurality of sensors, and

the authentication apparatus further includes:

an estimation unit which estimates a position and a leakage amount of a gas leaking from the target, based on a plurality of pieces of statistical information, each being identical to the statistical information.

### (Item 15)

The authentication apparatus according to item 14, further including

an issuing unit which, when the statistical information has been authenticated by the authentication unit, issues an electronic certificate certifying that the statistical information authenticated is the statistical information for the target, wherein

when the statistical information has been authenticated by the authentication unit, the issuing unit issues the electronic certificate certifying the position and the leakage amount of the gas estimated by the estimation unit are the position and the leakage amount of the gas leaking from the target.

### (Item 16)

An authentication system comprising:

the authentication apparatus according to any one of items 1 to 15; and

at least one of sensors, each being identical to the sensor.

### (Item 17)

An authentication method comprising:

receiving statistical information for a target transmitted from a sensor, the sensor having a measuring unit which measures environment information regarding surrounding environment of the target existing in a space and a statistics generation unit which generates, based on the environment information, the statistical information regarding the surrounding environment of the target; and

authenticating, based on the statistical information, that the statistical information is information regarding the surrounding environment of the target.

### (Item 18)

A program that causes a computer to function as:

a communication unit which receives statistical information for a target transmitted from a sensor, the sensor having a measuring unit which measures environment information regarding surrounding environment of the target existing in a space and a statistics generation unit which generates, based on the environment information, the statistical information regarding the surrounding environment of the target; and

an authentication unit which authenticates, based on the statistical information, that the statistical information is information regarding the surrounding environment of the target.

### EXPLANATION OF REFERENCES

10: authentication system;
20: space;
22: target object;
30: chimney;
40: pipe;
50: network;
100: sensor;
102: measuring unit;
104: statistics generation unit;
106: calibration unit;
108: storage unit;
110: encryption processing unit;
112: communication unit;
118: detection unit;
120: informing unit;
200: authentication apparatus;
202: communication unit;
204: decryption processing unit;
206: distribution generation unit;
208: derivation unit;
210: estimation unit;
212: authentication unit;
214: issuing unit;
216: storage unit;
1200: computer;
1210: host controller;
1212: CPU;
1214: RAM;
1220: input/output controller;
1222: communication interface;
1230: ROM.

What is claimed is:

1. An authentication apparatus comprising:
a communication unit which receives statistical information for a target transmitted from a sensor, the sensor having a measuring unit which measures environment information regarding surrounding environment of the target existing in a space and a statistics generation unit which generates, based on the environment information, the statistical information regarding the surrounding environment of the target; and
an authentication unit which authenticates, based on the statistical information, that the statistical information is information regarding the surrounding environment of the target.

2. The authentication apparatus according to claim 1, further comprising an issuing unit which, when the statistical information has been authenticated by the authentication unit, issues an electronic certificate certifying that the statistical information authenticated is the statistical information for the target.

3. The authentication apparatus according to claim 1, wherein the environment information represents at least one of a gas concentration, a dust amount, a temperature, a humidity, an atmospheric pressure, a noise, an illuminance, a vibration, an electromagnetic wave, a sound wave, an X-ray dose, a radiation dose, an ozone concentration, an airflow, a number of living organisms, postures of the living organisms, or positions of the living organisms to be measured in the space.

4. The authentication apparatus according to claim 1, wherein the statistical information includes at least one of an average value, a maximum value, a minimum value, a variance, a moment, or a histogram of measured values which are the environment information.

5. The authentication apparatus according to claim 1, wherein
the communication unit receives, from the sensor and along with the statistical information, sensor identification information that is for uniquely identifying the sensor, and
the authentication unit authenticates, based on the statistical information and the sensor identification information, that the statistical information is information regarding the surrounding environment of the target.

6. The authentication apparatus according to claim 5, wherein
the sensor is installed at a predetermined position of the space,
the sensor has a detection unit which detects whether the sensor is installed at the predetermined position, and a storage unit which stores installation information representing whether the sensor is installed at the predetermined position,
the communication unit receives the installation information along with the statistical information from the sensor, and
the authentication unit authenticates, based further on the installation information, that the statistical information is information regarding the surrounding environment of the target.

7. The authentication apparatus according to claim 1, wherein
the sensor includes a plurality of sensors, each being identical to the sensor and arranged in a target region, and the communication unit receives, from each of the plurality of sensors, the statistical information and position identifying information that is for identifying a position of each of the plurality of sensors, and
the authentication apparatus further comprises:
a distribution generation unit which generates distribution information regarding environment of the target region, based on a plurality of pieces of statistical information, each being identical to the statistical information, and on a plurality of pieces of position identifying information, each being identical to the position identifying information.

8. The authentication apparatus according to claim 7, wherein
the communication unit receives distribution information, regarding environment of a wide region, based on an observation result obtained by an observation satellite which observes environment information regarding the environment of the wide region including the target region, and
the distribution generation unit generates the distribution information regarding the environment of the target region, based on the plurality of pieces of statistical information and the plurality of pieces of position identifying information, and on the distribution information based on the observation result.

9. The authentication apparatus according to claim 7, further comprising
an issuing unit which, when the statistical information has been authenticated by the authentication unit, issues an electronic certificate certifying that the statistical information authenticated is the statistical information for the target, wherein
when the statistical information has been authenticated by the authentication unit, the issuing unit issues the electronic certificate certifying that the distribution information generated by the distribution generation unit is distribution information based on the statistical information for the target.

10. The authentication apparatus according to claim 7, further comprising
an issuing unit which, when the statistical information has been authenticated by the authentication unit, issues an electronic certificate certifying that the statistical information authenticated is the statistical information for the target, wherein
when the statistical information has been authenticated by the authentication unit, the issuing unit issues the electronic certificate certifying that the distribution information generated by the distribution generation unit is the distribution information regarding the environment of the target region.

11. The authentication apparatus according to claim 1, wherein
the measuring unit measures, as the environment information, a gas concentration and a gas flow velocity of a gas passing through the target, and
the statistics generation unit generates, as the statistical information, statistical values of the gas concentration and the gas flow velocity, and
the authentication apparatus further comprises:
a derivation unit which derives, based on the statistical values of the gas concentration and the gas flow velocity represented by the statistical information, a total amount of the gas passing through the target.

12. The authentication apparatus according to claim 11, further comprising
an issuing unit which, when the statistical information has been authenticated by the authentication unit, issues an electronic certificate certifying that the statistical information authenticated is the statistical information for the target, wherein
when the statistical information has been authenticated by the authentication unit, the issuing unit issues the electronic certificate certifying that the total amount of the gas derived by the derivation unit is a total amount of the gas passing through the target.

13. The authentication apparatus according to claim 12, wherein the gas is a greenhouse gas.

14. The authentication apparatus according to claim 7, wherein
the measuring unit measures, as the environment information, a gas concentration and a gas flow velocity of a gas passing through the target,
the distribution generation unit generates gas concentration distribution information as the distribution information, and
the authentication apparatus further comprises:
a derivation unit which interpolates and predicts, based on the gas concentration distribution information and on computation by computational fluid dynamics, the gas concentration distribution, and further derives a total amount of the gas passing through the target.

15. The authentication apparatus according to claim 1, wherein
the sensor includes a plurality of sensors, each being identical to the sensor, the plurality of sensors being arranged at a plurality of positions of the target,
the communication unit receives the statistical information from each of the plurality of sensors, and
the authentication apparatus further comprises:
an estimation unit which estimates a position and a leakage amount of a gas leaking from the target, based on a plurality of pieces of statistical information, each being identical to the statistical information.

16. The authentication apparatus according to claim 15, further comprising
an issuing unit which, when the statistical information has been authenticated by the authentication unit, issues an electronic certificate certifying that the statistical information authenticated is the statistical information for the target, wherein
when the statistical information has been authenticated by the authentication unit, the issuing unit issues the electronic certificate certifying that the position and the leakage amount of the gas estimated by the estimation unit are the position and the leakage amount of the gas leaking from the target.

17. An authentication system comprising:
the authentication apparatus according to claim 1; and
at least one of sensors, each being identical to the sensor.

18. An authentication system comprising:
the authentication apparatus according to claim 7; and
at least one of sensors, each being identical to the sensor.

19. An authentication method comprising:
receiving, by a communication unit of an authentication apparatus, statistical information for a target transmitted from a sensor, the sensor having a measuring unit which measures environment information regarding surrounding environment of the target existing in a space and a statistics generation unit which generates, based on the environment information, the statistical information regarding the surrounding environment of the target; and
authenticating, by an authentication unit of the authentication apparatus and based on the statistical information, that the statistical information is information regarding the surrounding environment of the target.

20. A computer readable medium having stored thereon a program that causes a computer to function as:
a communication unit which receives statistical information for a target transmitted from a sensor, the sensor having a measuring unit which measures environment information regarding surrounding environment of the target existing in a space and a statistics generation unit which generates, based on the environment information, the statistical information regarding the surrounding environment of the target; and
an authentication unit which authenticates, based on the statistical information, that the statistical information is information regarding the surrounding environment of the target.
